(19) United States
(12) Patent Application Publication
(10) Pub. No.: US 2024/0394286 A1
(43) Pub. Date: Nov. 28, 2024

(54) TASK PERFORMANCE USING LANGUAGE MODELS

(71) Applicant: X Development LLC, Mountain View, CA (US)

(72) Inventors: Garrett Raymond Honke, Mountain View, CA (US); Jeffrey Bush, Los Altos, CA (US); Klara Kaleb, London (GB); Brian Mark Rosen, San Francisco, CA (US); David Andre, San Francisco, CA (US)

(21) Appl. No.: 18/674,444

(22) Filed: May 24, 2024

Related U.S. Application Data
(60) Provisional application No. 63/504,596, filed on May 26, 2023.

(51) Int. Cl. G06F 16/332; G06F 16/33; G06F 40/284

(52) U.S. Cl. CPC G06F 16/3329; G06F 16/3344; G06F 16/3346; G06F 40/284

(57) ABSTRACT

Methods, systems, and apparatus, including computer programs encoded on computer storage media, for performing tasks. One of the methods includes obtaining a prompt, obtaining a set of documents, generating an input, providing the input to a plurality of language models, generating a distribution from intermediate answers from the language models; and generating an answer to the prompt by performing a probabilistic inference over the distribution.

### CROSS-REFERENCE TO RELATED APPLICATION

This application claims priority to U.S. Provisional Application No. 63/504,596, filed on May 26, 2023. The disclosure of the prior application is considered part of and is incorporated by reference in the disclosure of this application.

### BACKGROUND

This specification relates to performing a machine learning task on an input using language models.

Language models are machine learning models that can employ one or more layers of nonlinear units to predict an output for a received input. Language models can receive an input of a prompt posed in natural language text, for example, and predict an answer to the question in natural language text.

Many prompts are more complex and an ideal answer or solution that addresses the prompt may involve many uncertainties or nuances. However, many conventional systems that provide answers to prompts output one answer for a received input prompt, leading to missing information, a false sense of confidence in the solution, or difficulties in surfacing and exploring the nuances of the solution.

### SUMMARY

This specification describes a system implemented as computer programs on one or more computers in one or more locations that performs a machine learning task on a network input using language models. For example, the system can generate an answer to a prompt of natural language text using multiple language models.

In general, one innovative aspect of the subject matter described in this specification can be embodied in methods that include the actions of obtaining a prompt comprising natural language text; obtaining a set of documents comprising natural language text; generating an input comprising at least the set of documents and the prompt; providing the input to a plurality of language models, wherein each language model is configured to generate at least an intermediate answer to the prompt from the input; generating a distribution from the intermediate answers; and generating an answer to the prompt by performing a probabilistic inference over the distribution, the answer comprising natural language text.

Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The foregoing and other embodiments can each optionally include one or more of the following features, alone or in combination. In particular, one embodiment includes all the following features in combination.

In some implementations, generating a distribution comprises clustering the intermediate answers based on similarity of each intermediate answer to each other intermediate answer.

In some implementations, the plurality of language models comprise instances of a same language model.

In some implementations, the plurality of language models comprise different language models.

In some implementations, the method further comprises: generating a modified input comprising at least the answer and the set of documents; providing the modified input to a plurality of language models, wherein each language model is configured to generate at least a secondary intermediate answer to the prompt from the modified input; generating a second distribution from the secondary intermediate answers; and generating a response to the modified input by performing a probabilistic inference over the second distribution, the response comprising natural language text.

Another innovative aspect of the subject matter described in this specification can be embodied in methods that include the actions of obtaining a prompt comprising natural language text; obtaining a set of documents comprising natural language text; generating an input comprising at least the set of documents and the prompt; providing the input to a plurality of language models, wherein each language model is configured to generate at least an intermediate answer to the prompt from the input; for each language model: generating a distribution of a plurality of intermediate answers by providing the input to the language model multiple times; and generating an answer comprising natural language text to the prompt by performing a probabilistic inference over each distribution.

Other embodiments of this aspect include corresponding computer systems, apparatus, and computer programs recorded on one or more computer storage devices, each configured to perform the actions of the methods.

The foregoing and other embodiments can each optionally include one or more of the following features, alone or in combination. In particular, one embodiment includes all the following features in combination.

In some implementations, generating a distribution comprises clustering the intermediate answers based on similarity of each intermediate answer to each other intermediate answer.

In some implementations, the plurality of language models comprise multiple instances of a same language model.

In some implementations, the input to each language model comprises a different prompt.

In some implementations, obtaining a set of documents comprising natural language text further comprises obtaining a subset of the set of documents, wherein each document in the subset comprises text that is relevant to the prompt.

In some implementations, the method further comprises: receiving a request for an alternative to the answer; and generating a second answer comprising natural language text to the prompt.

In some implementations, the method further comprises: receiving a request for an explanation for the answer; and generating an explanation comprising natural language text for the answer.

In some implementations, the method further comprises: obtaining a second prompt comprising a deterministic answer comprising natural language text to the prompt; generating a modified input comprising at least the second prompt and the set of documents; providing the modified input to a plurality of language models, wherein each language model is configured to generate at least an intermediate answer to the prompt from the modified input; for each language model: generating a distribution of a plurality of intermediate answers by providing the modified input to the language model multiple times; and generating an answer comprising natural language text to the prompt by performing a probabilistic inference over each distribution.

In some implementations, the method further comprises: generating a second prompt that comprises different text with a same meaning as the text of the prompt; for each language model: generating a first distribution of a plurality of first intermediate answers by providing the input to the language model multiple times; generating a second distribution of a plurality of second intermediate answers by providing an input comprising at least the set of documents and the second prompt to the language model; and generating the answer by performing a probabilistic inference over each distribution.

Particular embodiments of the subject matter described in this specification can be implemented to realize one or more of the following advantages.

The system can automate the development of arguments and responses to queries, and drafting of documents, increasing efficiency and reducing the usage of computing time and resources compared to developing arguments and responses to queries or to drafting documents by hand or with conventional systems. Developing arguments and drafting documents can require searching through, filtering, and understanding a large amount of data, which can be impractical to do manually. For example, developing arguments manually typically includes developing arguments serially, i.e., one at a time. The system described in this specification can generate multiple arguments and/or responses to queries in parallel in a short amount of time, e.g., at least five, ten, 25, 50, 100, 200, 400, or 800 arguments and/or responses per second depending on a variety of factors such as the computing resources being used and the number and size of documents. Evaluating multiple arguments and/or responses can also require searching through, filtering, and understanding a large amount of data, and can also be impractical to do manually. The system described in this specification can evaluate multiple arguments and/or responses, e.g., at least five, ten, 25, 50, 100, 200, 400 or 800 arguments and/or responses, to determine a final answer in a short amount of time, e.g., less than one, five, ten, or 20 seconds. The system can provide answers in such a short period of time when analyzing a large number of documents (e.g., more than five, ten, 25, 50 or 100 documents and/or document(s) that represent more than 50, 100, 250, 500, 1000, 2500, 5000, 10,000, or 100,000 tokens and to which a prompt is directed.

Conventional systems that draft documents or answer questions provide one document or one answer to a question. Conventional systems do not provide insight into any potential steps or chains of reasoning that led to the document or answer. Some conventional systems also do not provide insight into uncertainties or nuances in parts of the document or answer. Thus conventional systems may disregard many potential answers or parts of answers that could be interesting to a user, or whose exploration could lead to different answers. The techniques described in this specification allow for quantifying ambiguities in answers or parts of answers, and for further exploration of other potential answers or parts of answers. The system described in this specification can, for example, represent ambiguity using a distribution of intermediate answers, or parts of answers, generated by providing the same input to a language model multiple times to generate multiple intermediate answers. The system can cluster the intermediate answers in the distribution. The system can select the most probable intermediate answer as the answer, or explore the less likely intermediate answers. In addition, while a human or conventional system may only develop a single argument at a time, the system can allow for the parallel development of multiple chains of arguments from different perspectives.

Furthermore, some conventional systems do not allow for user input during generation of the document or answer given a prompt. The system described in this specification can allow for external biases to affect the answer. For example, the system can obtain a second prompt representing an external bias for the answer, for example, through user input. The system can modify the prompt with the second prompt at a certain step in the generation of the answer to generate a document or answer that takes into account the external biases of the user.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example answer generation system.

FIG. 2 is a flow diagram of an example process for generating an answer.

FIG. 3 is a flow diagram of another example process for generating an answer.

FIG. 4 is a flow chart of an example process for generating an answer.

FIG. 5 shows an example of a distribution of intermediate answers from a language model.

FIG. 6 depicts a schematic diagram of a computer system that may be applied to any of the computer-implemented methods and other techniques described herein.

Like reference numbers and designations in the various drawings indicate like elements.

### DETAILED DESCRIPTION

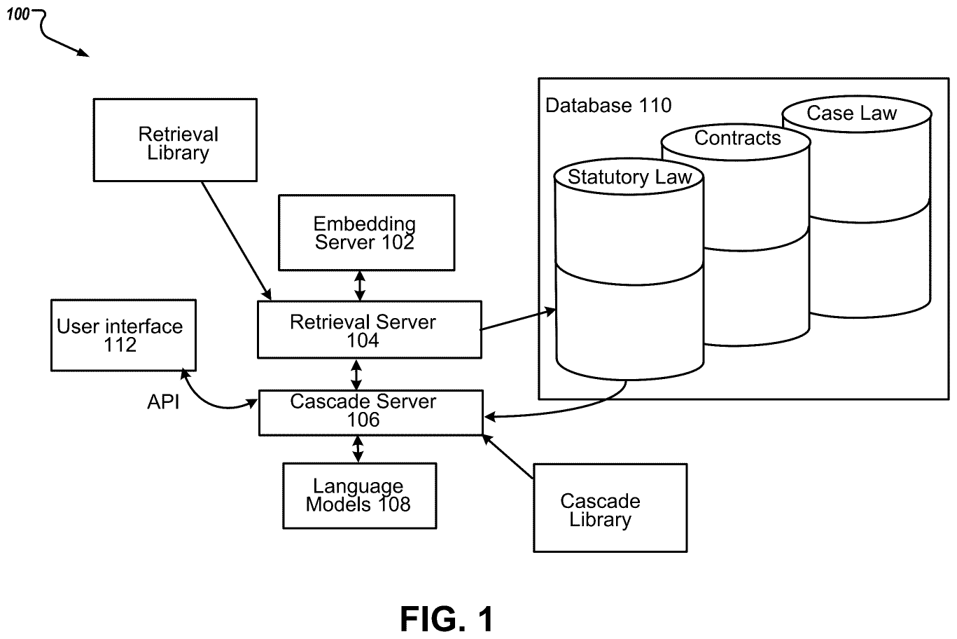

FIG. 1 shows an example answer generation system 100. The system 100 is an example of a system implemented as computer programs on one or more computers in one or more locations. The system 100 can include an embedding server 102, a retrieval server 104, a cascade server 106, language models 108, a database 110, and a user interface 112. In some implementations, the components can be part of a same system and/or network of computing devices and/or systems.

The user interface 112 can be configured to allow a user to interact with the system 100. For example, the user interface 112 can allow a user to input natural language prompts and receive natural language answers from the system 100. For example, the user interface 112 may include a front-end and a back-end user experience. The user interface 112 can also allow a user to interact directly with components of the system 100. For example, the user interface 112 can allow a user to interact with, e.g., upload, edit, view, and/or download, documents stored in the database 110.

The embedding server 102 can be any appropriate computing system that is configured to generate embeddings of data such as text or images. An “embedding,” as used in this specification is a vector of numeric values, e.g., floating point or other type of numeric values, that has a predetermined dimensionality, e.g., has a predetermined number of values. For example, the embedding server 102 can generate embeddings of text in documents stored in the database 110 in an embedding space. As an example, the embedding server 102 can generate a respective embedding for each document by embedding the text in the document. The embedding server 102 can also generate embeddings of queries or outputs from the language models 108.

In some implementations, the embedding server can use an embedding engine that can be finetuned on training data for a particular domain, such as the legal domain. In some examples, the embedding engine can be an encoder neural network or a large language model such as Gemini, Gemma, or PaLM.

The embedding server 102 can also perform operations such as clustering of the embeddings. For example, the embedding server 102 can perform agglomerative hierarchical clustering over the same space to learn categories or clusters of documents at different levels of specificity in a hierarchy. As an example, each level of specificity can have a cutoff in similarity. The similarity can be measured, for example, as a Euclidean distance or cosine similarity. Each document can be included in one or more clusters at different levels. As another example, the embedding server 102 can perform density-based spatial clustering of applications with noise (DBSCAN) to cluster the embeddings.

The retrieval server 104 can be any appropriate computing system that is configured to obtain documents from the database 110. The retrieval server 104 can provide the data in documents to the embedding server 102 and the cascade server 106. In some implementations the retrieval server 104 can use a retrieval library.

The retrieval server 104 can also use embedding information from the embedding server 102 to more efficiently and effectively obtain relevant documents from the database 110. For example, the retrieval server 104 can retrieve documents that are relevant by embedding lures and pulling the nearest neighbors in embedding space. For example, to retrieve documents that are relevant to a particular sequence of text, the retrieval server 104 can obtain the embedding for the particular sequence of text, and identify documents with embeddings that are close to the embedding for the particular sequence of text as documents that are relevant. As an example, the documents with embeddings that are close can each have a similarity to the particular sequence of text, e.g., a cosine similarity, that is within a threshold similarity. In some examples, the threshold similarity can be a predetermined threshold similarity. In some examples, the threshold similarity can be defined by a user.

As another example, the documents that are relevant can be in the same cluster in the hierarchy. For example, for a threshold cutoff, the retrieval server 104 can identify documents included in the same cluster as the particular sequence of text for the level that has the threshold cutoff.

The database 110 can be any appropriate computing system that is configured to store documents. For example, the database 110 can include documents relating to statutory law, contracts, case law, etc.

The cascade server 106 can be any appropriate computing system that is configured to store and run programs that call the language models 108 and run retrieval programs. The cascade server 106 can be configured to make multiple calls to the language models 108. For example, the cascade server 106 can be configured to make calls to the language models 108 by generating prompts for and providing prompts to one or more of the language models 108. In some implementations the cascade server 106 can use a cascade library.

In some examples, the cascade server 106 can also process the data received from the language models 108 and/or the retrieval server 104. For example, the cascade server 106 can sample multiple intermediate answers from the language models 108, cluster the intermediate answers, and generate a final answer from the intermediate answers.

As an example, for a particular question, the cascade server 106 can receive data from the language models 108 that includes multiple intermediate answers. The cascade server 106 can cluster the intermediate answers into a number of groups of intermediate answers. For example, the cascade server 106 can embed each intermediate answer and cluster the intermediate answers into groups. For each group of intermediate answers, the cascade server 106 can generate a representative answer. For example, the cascade server 106 can provide each group of intermediate answers and a request to generate a representative answer for the group to the language models 108. In some examples, the cascade server 106 can provide the question and each representative answer in a multiple choice format to the language models 108 to obtain a final answer.

The language models 108 can be any appropriate machine learning models that are configured to generate an output sequence of tokens given an input sequence. For example, the input sequence can be a prompt of natural language text. The output sequence can be an answer to the prompt in natural language text. For example, the language model 108 can be a large language model.

As an example, a user of the user interface 112 may input a prompt asking for examples of indemnity clauses. The system 100 can use an API to provide the prompt to the cascade server 106. The cascade server 106 can process the prompt to generate a language model prompt that can be used to respond to the prompt from the user, for example. The cascade server 106 can also process the prompt from the user to identify text from the prompt to be embedded and used as an embedding lure for the retrieval server 104. In some examples, the cascade server 106 can call one or more language models 108 to understand the query and determine which programs are relevant.

The system 100 can use the retrieval server to retrieve documents from the database 110, embed data in those documents using the embedding server 102, and provide the data or embedded data to the cascade server 106. The system 100 can then use the programs of the cascade server to provide the data and the prompt to the language models 108. The language models 108 can generate one or more answers, and the cascade server 106 can receive the one or more answers. The system 100 can provide the answers or display the answers to the user through the user interface 112.

Although this example relates to legal documents and legal issues, the system 100 can be used to generate many types of answers, or to perform many types of tasks. For example, with appropriate types of data stored in the database 110, the system 100 can be used for processing large numbers of documents in fields such as contract management, real estate documentation, accounting. The system 100 can also be used for processing large numbers of documents to identify trends in fields such as investing.

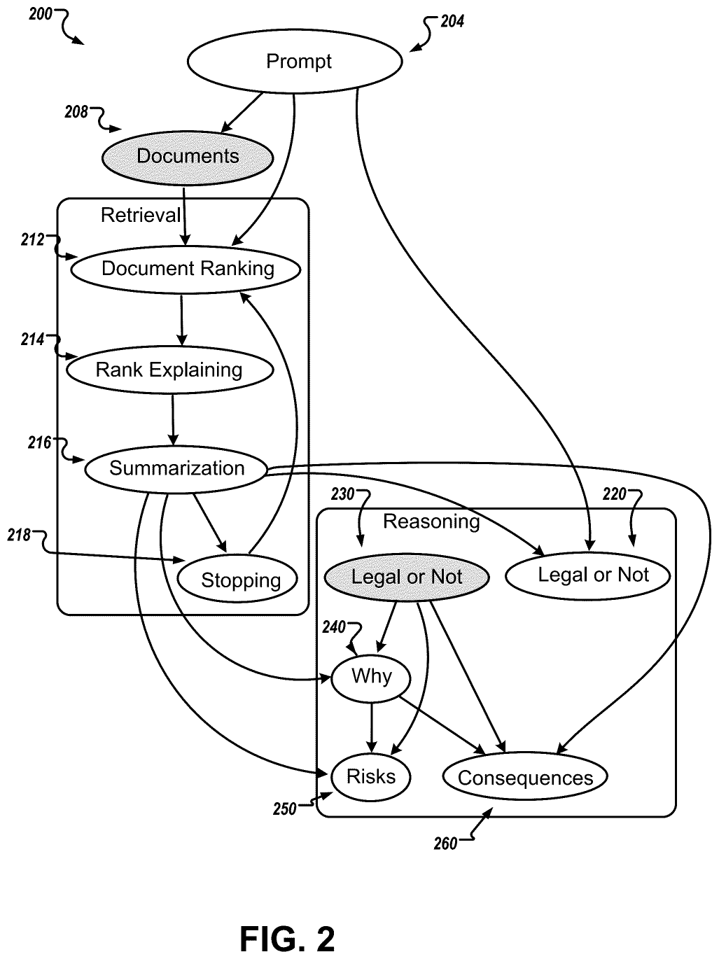

FIG. 2 is a flow diagram of an example process 200 for generating an answer. For convenience, the process 200 will be described as being performed by a system of one or more computers located in one or more locations. For example, a system such as the system 100 of FIG. 1, appropriately programmed in accordance with this specification, can perform the process 200.

The system can obtain a prompt 204. For example, the prompt can include natural language text. The prompt can include a set of facts and a question. For example, the prompt can include “Is someone allowed to eat a frog that has participated in a frog hopping contest?” The system can obtain the prompt 204 from a user input, for example.

The system can retrieve a set of documents 208. The documents 208 can include data of different data types, such as text, images, or data. The documents 208 can include legal documents, statutes, regulations, cases, etc.

In some implementations, the system can process the documents 208 to filter the set of documents 208. For example, the system can filter the set of documents 208 into a subset of documents that is related to the prompt in order to provide more relevant answers and find relevant information more efficiently. The system can generate a document ranking 212, for example, that ranks each document in documents 208 by how relevant they are to the prompt. The system can generate the document ranking 212 by providing the prompt and the documents to a language model, for example. In some implementations, the language model can output a binary answer of whether a document is relevant to the prompt. In some implementations, the language model can output a score that represents how relevant a document is to the prompt. For example, the system can include a particular part of a prompt that asks the model to provide a score in some range in the prompt to the language model. In some examples, the system can use instruction fine-tuning to further train the model to generate scores. In some examples, the system can use few-shot learning by providing examples of prompts, documents, and scores as part of the prompt to the language model.

In some examples, the system can generate the document ranking 212 based on similarity scores between each document and the prompt. For example, the system can obtain an embedding for the prompt and each document. The system can rank each document in documents 208 by decreasing similarity score to the embedding of the prompt.

In some implementations, the system can use a language model to perform rank explaining 214. The system can use a language model to perform summarization 216. For example, the system can use the language model to obtain an explanation of the document ranking 212, or to obtain summaries of the documents, or to obtain summaries of why the documents are relevant. For example, the system can use the language model to obtain an explanation of why a particular document is more relevant to the prompt than other documents. As another example, the system can use the language model to obtain a summarization of the explanation or a summarization of the relevance of the documents to the prompt 204.

As an example, the prompt 204 can include a fact pattern. The set of documents 208 can include a court decision that lays out the rationale for the decision. The score that represents the document's relevance to the prompt can be 7 out of 10, for example. The explanation of the rank that is output from performing rank explaining 214 can include “the statute plainly states it is about the [fact pattern in prompt 204] and is for the jurisdiction of the [fact pattern in prompt 204], so it is ranked as a 7.”

As another example, a summarization of the relevance can include “the statute is about the given fact pattern and is for the jurisdiction of the given fact pattern.”

The system can include documents in the subset of documents that are related to the prompt. For example, the system can include the top-x documents according to the document ranking 212 in the subset, where x is an integer greater than or equal to one. As another example, the system can include documents with a relevance score that meets a threshold relevance score in the subset of documents.

After the system retrieves a set of documents 208 or subset of documents, the system can stop retrieval at 218. The system can then provide the documents 208, or subset of documents, to one or more language models for reasoning.

In some examples, the system can stop retrieval in response to determining that the system has processed all documents of the documents 208. In some examples, the system can stop retrieval in response to determining that the system has processed all documents of the documents 208 that meet a threshold similarity to the prompt 204. For example, if the system has processed all documents of the documents 208 that have a similarity score to the prompt 204 that is greater than or equal to a threshold similarity score, the system can stop retrieval.

In some examples, the system can stop retrieval in response to determining that the system has a sufficient amount of information to generate an answer to the prompt 204. For example, the system can provide the fact pattern from the prompt 204, the question from the prompt 204, the text of one or more relevant documents, and/or the summarization of relevance of the documents to the prompt 204, and a request to determine whether the information in the text of the one or more relevant documents is sufficient for generating an answer to the question.

For example, the prompt can include a question about a crime that has five elements. The one or more relevant documents can include text about four of the five elements. The system can receive an output from the language model that indicates there is not enough information to generate an answer to the question. In this example, the system can continue retrieval to include a larger number of documents in the subset of relevant documents, e.g., by decreasing the threshold similarity score by a predetermined amount and/or decreasing the threshold relevance score by a predetermined amount.

In some examples, the system can provide an answer that indicates the system does not have enough information to answer the question. For example, after determining that retrieval cannot be stopped for a threshold number of iterations, the system can provide an answer indicating the system does not have enough information to answer the question. As another example, after determining that retrieval cannot be stopped and all documents of the documents 208 have been included in the subset of documents, the system can provide an answer indicating the system does not have enough information to answer the question.

The system can generate an answer 220 such as whether the prompt is “legal or not.” In some examples, the answer 220 can include an explanation for the answer.

For example, to generate the answer 220, the system can generate a distribution of intermediate answers or answers by providing the prompt 204 and the documents 208, or subset of documents, to a language model. In some implementations, the system can modify the prompt 204 before providing the prompt to the language model. For example, the system can include the fact pattern from the prompt 204, the question from the prompt 204, the text of one or more relevant documents, and/or the summarization of relevance of the documents to the prompt 204. The system can also include a request for an answer and an explanation for the answer.

In some implementations, the system can provide the prompt to more than one language model. In some implementations, the system can provide different versions of the prompt to different language models. In some implementations, the system can provide different versions of the prompt to the same language model. For example, different versions of the prompt can have different capitalization, or include different synonyms with the same meaning as the prompt.

In some implementations, the system can include the intermediate answer or answer from one language model in a further prompt to the same language model or a different language model. For example, the system can include the intermediate answer from one language model in a further prompt to a language model when the likelihood of the answer being correct based on the information provided and based on the distribution of intermediate answers is above a specified threshold. For example, the system can include a request in the further prompt to generate an answer from the intermediate answer.

The system can generate the answer 220 by performing a probabilistic inference over the distribution of intermediate answers. The explanations for the intermediate answers, e.g., answers that indicate that the fact pattern in the prompt constitute a legal action, may differ. The system can thus perform clustering. For example, the system can cluster the answers by the conclusion of whether the facts in the prompt constitute a legal action or not. For example, 60% of the intermediate answers or answers can indicate that the facts in the prompt constitute a legal action, and 40% of the intermediate answers or answers can indicate that the facts in the prompt constitute a non-legal action. The system can include the conclusion that the facts in the prompt are legal in the answer 220. The system can also provide an explanation of the answer 220, for example, by using a language model over the different intermediate answers in the “legal” cluster. In some implementations, the system can use a language model to summarize the reasons or evidence that the facts in the prompt are legal, or to summarize the reasons or evidence that the facts in the prompt are not legal. In some implementations, the system can provide a measure of confidence in each answer or cluster of answers.

In some examples, the system can also generate potential outcomes, strategy, risks, and/or consequences. For example, the system can obtain potential outcomes, strategy, risks, and/or consequences from the language model by including a request to generate answers that include potential outcomes, strategy, risks, and/or consequences in the prompt to the language model. The system can also include the answer 220, the explanation for the answer 220, and/or the prompt 204 in the prompt to the language model. In some examples, the system can determine potential outcomes, strategy, and/or consequences using a distribution of potential outcomes, strategy, risks, and/or consequences obtained using the language model, as described above with reference to generating the answer 220 using a distribution of intermediate answers.

In some examples, the system can also generate a measure of risk using the language model. For example, the system can provide the answer 220, the explanation for the answer 220, and/or the prompt 204, and a request to generate a score for how risky the answer 220 is. The score can be, for example, a scalar output on a range, or a binary output, or a description such as “low,” “medium,” or “high.”

In some implementations, the system can provide an alternative answer to the answer 220. For example, the system can receive a request for an alternative to the answer 220. The system can provide an answer with the same conclusion but different reasons, or an answer with a different conclusion, for example. As an example, the answer 220 can include a conclusion that the facts in the prompt are not legal. The system can obtain the alternative answer by providing the answer 220, the prompt 204, and/or the explanation for the answer 220 with an appropriate request to generate an alternative answer to the language model.

The system can also provide reasons 240 for why the facts in the prompt are not legal, as well as potential outcomes and strategy in litigation, for example. A user can edit the answer 220 to include a different conclusion, for example, that the facts in the prompt are legal. The system can thus include the edited answer 220 in a new prompt 204, and perform the process 200 to provide reasons 240 for why the facts in the new prompt are legal, and potential outcomes and strategy.

In some implementations, the system can inject a deterministic node 230, “legal or not,” during reasoning. For example, the system can obtain a prompt from a user that indicates that the user thinks the facts in the prompt are legal. The system can use the one or more language models to determine reasons 240 for why the facts in the prompt are legal. The system can also use one or more language models to determine the risks 250 and/or the consequences 260 if the facts in the prompt are considered to be legal. Thus, the system can receive external biases that can affect the answers and conclusions of the language models.

The system can thus provide different answers, or different conclusions with different arguments, to one prompt. Thus, a system that generates a document or answer to a prompt can generate multiple documents or answers from which a user can select.

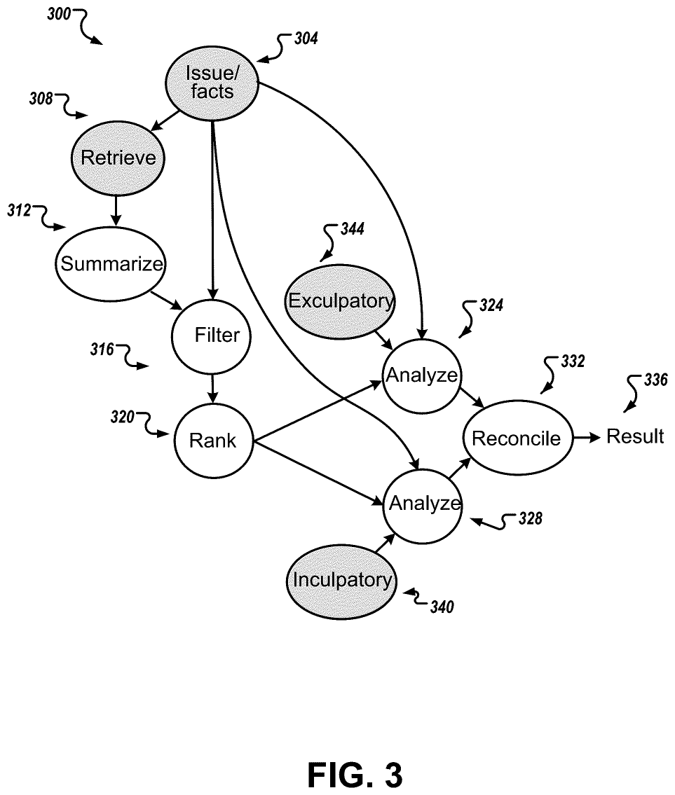

FIG. 3 is another flow diagram of an example process 300 for generating an answer. The process 300 can be performed by a system such as system 100, for example.

The process 300 is similar to the process 200. For example, the system obtains a prompt 304. The prompt 304 can include facts, an issue, and/or a question.

The system can retrieve documents 308. The system can summarize the documents 312, for example, using a language model. The system can filter the documents 316, for example, using a language model. The system can rank the documents 320, for example, by relevance, using a language model.

The system can use the prompt 304 and the most relevant documents to analyze the issue presented in the prompt. For example, the system can generate an answer to the prompt, as discussed above. The system can receive a request to explain or analyze the answer. For example, the request can be a request 344 to explain why the answer is exculpatory. The request can also be a request 340 to explain why the answer is inculpatory. The system can provide the request 340 or 344, the most relevant documents, and the prompt to a language model to perform an analysis 324 or 328 of reasons why the answer is exculpatory or inculpatory. The system can reconcile the reasons 332, for example, using a language model, to determine a final answer 336. The final answer may, for example, include a synthesis or discussion of the most relevant exculpatory and inculpatory reasons.

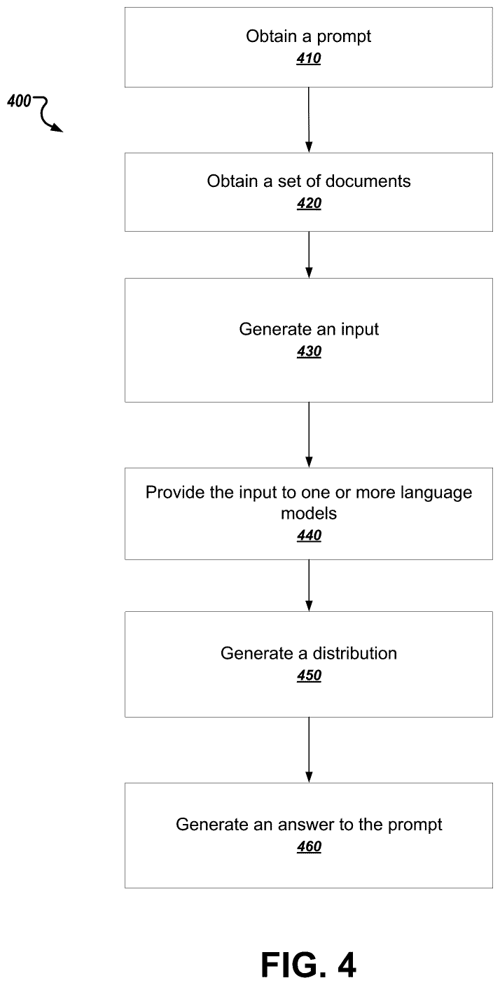

FIG. 4 is a flow chart of an example process for generating an answer. The process 400 can be performed by a system such as system 100, for example.

The system can obtain a prompt (410). The prompt can include, for example, natural language text.

In some examples, the prompt includes an open-ended question or request to generate a document. In some examples, the prompt includes a multiple-choice question with multiple choice options.

The system can obtain a set of documents (420). The set of documents can include, for example, natural language text. In some implementations, the system can filter the set of documents into a subset of documents. The subset of documents can include documents from the set of documents that are relevant to the prompt. For example, the system can use a language model to determine which documents are relevant to the prompt.

The system can generate an input (430). The input can include, for example, the set of documents and the prompt. In some implementations, the input can include the subset of documents that are relevant to the prompt and the prompt.

The system can provide the input to one or more language models (440). Each language model can be configured to generate at least an intermediate answer to the prompt from the input. An intermediate answer can include, for example, text representing a span of one or more text tokens, that is not a direct answer to the prompt. In some examples, each language model can be configured to generate an intermediate answer that can be used directly as an answer to the prompt. For example, if the prompt includes a multiple-choice question, an intermediate answer that can be used directly as an answer to the prompt includes a letter indicating a multiple choice option.

For example, a system can provide the input to one or more language models by calling the language model. In some implementations, the system can provide the input to the same language model. In some implementations, the system can provide the input to instances of the same language model. In some implementations, the system can provide the input to different language models. In yet other implementations, the system can provide input to 1) a set of instances of one language model and 2) a second different language model alone or to a set of instances of the second different language model.

The system can provide the input to the one or more language models multiple times, e.g., by sampling from the one or more language models. The system can thus obtain multiple intermediate answers from the one or more language models.

In some implementations, the input to each language model can be different. For example, the system can modify the prompt, e.g., with synonyms, to each language model.

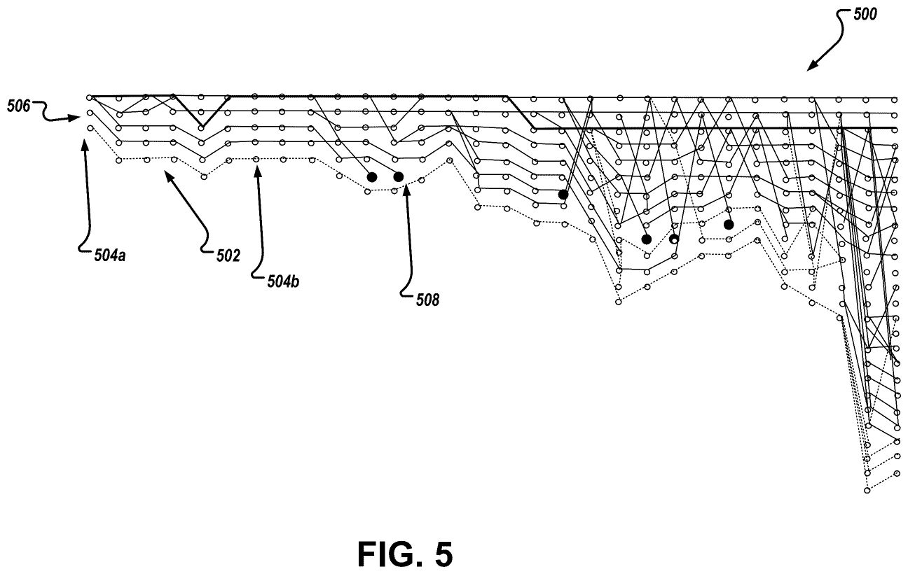

The system can generate a distribution (450). The system can generate the distribution from intermediate answers. For example, a visualization of a distribution is shown below in FIG. 5. In some implementations, generating a distribution can include clustering the intermediate answers based on the similarity of each intermediate answer to each other intermediate answer. For example, the similarity can be a cosine similarity between embeddings of the intermediate answers.

In some implementations, the system can use validation nodes to cluster sets of similar intermediate answers to the prompt. In some examples, the system can use validation nodes to confirm some assertion about text that the model has produced. For example, the system can include a verifier model to filter intermediate answers. In some examples, the verifier model can be one of the one or more language models. In some examples, the verifier model can be trained or fine-tuned to confirm the assertion about text. For example, the verifier model can confirm assertions for criteria such as logically consistent, factual, creative, etc. The system can remove intermediate answers that do not meet the criteria. As a particular example, a verifier model that confirms whether an intermediate answer is logically consistent can be configured to generate a truth tree for the intermediate answer.

In implementations where the system provides the input to different language models, the system can generate a distribution for each language model or a distribution of answers provided by different language models.

The system can generate an answer to the prompt (460). For example, the system can perform a probabilistic inference over the distribution. The answer can include natural language text.

In some implementations, the system can cluster the intermediate answers. As a particular example, if the prompt includes a multiple choice question, each intermediate answer can include a multiple choice option selected by the language models and/or an explanation for the selected multiple choice option. The system can cluster the intermediate answers for each multiple choice option. The system can generate the answer to the prompt by selecting the multiple choice option with the largest number of intermediate answers.

In some examples, the system can determine a level of confidence for the answer to the prompt. For example, the system can use the proportion of the number of intermediate answers for the selected multiple choice option relative to the total number of intermediate answers as a measure of confidence.

In some examples, the system can use the level of confidence to further refine the answer to the prompt. For example, if the difference between the level of confidence for the selected multiple choice option and one or more other levels of confidence for other multiple choice options is less than a threshold percentage, the system can provide the selected multiple choice option and the other multiple choice options to the one or more language models, along with a request to break the tie. The system can use the multiple choice option selected by the one or more language models as the answer.

In some examples, the system can use the level of confidence to provide context to the user. For example, if the difference between the level of confidence for the selected multiple choice option and one or more other levels of confidence for other multiple choice options is less than a threshold percentage, the system can indicate that the provided answer is ambiguous. In some examples, the system can generate explanations for the selected multiple choice option and the other multiple choice options, e.g., using the one or more language models, for presentation to the user.

As another example, if the prompt includes an open-ended question, each intermediate answer can include an intermediate answer that is a direct answer to the question. The system can cluster the intermediate answers into a number of groups of intermediate answers. For example, the system can embed each intermediate answer and cluster the intermediate answers into groups based on similarity. For each group of intermediate answers, the system can generate a representative answer. For example, the system can provide each group of intermediate answers and a request to generate a representative answer for the group to the one or more language models. In some examples, the system can provide each group of intermediate answers and a request to generate a summary for the intermediate answers for the group to the one or more language models to obtain a summary for each cluster. The system can then provide the summary for each cluster and a request to consolidate the summary into a representative answer.

The system can generate an answer to the prompt by providing a second prompt that includes the prompt and the representative answers in a multiple choice format to the one or more language models. The system can perform the process 400 for the second prompt. In particular, the system can perform step 460 for the multiple choice question as described above.

In some examples where each intermediate answer is a direct answer to the question, the system can generate the answer by providing the intermediate answers and a request to select the best answer to the one or more language models.

In some examples where the prompt includes an open-ended question, each intermediate answer can include at least part of an answer to the question. For example, the system can generate multiple intermediate answers using a language model. The system can cluster the intermediate answers into multiple clusters. The system can cluster the intermediate answers into multiple clusters using embeddings, bag of words, or other clustering analyses. As an example, the system can generate embeddings for each of the intermediate answers. The system can cluster, e.g., using unsupervised clustering, each of the intermediate answers in the embedding space.

The system can summarize each cluster, e.g., by generating a representative intermediate answer for the cluster. In some examples, the system can sample from each cluster to generate a representative intermediate answer. In some implementations, the system can use a language model to summarize each cluster and generate a representative intermediate answer.

The system can generate intermediate answers for a second expansion step conditioned on one or more representative intermediate answers of a previous expansion step. For example, the system can provide each representative intermediate answer, the prompt, the relevant documents, and a request to generate another intermediate answer to the one or more language models. The system can cluster the intermediate answers for the expansion step, and generate representative intermediate answers for the expansion step. The system can generate further representative intermediate answers for further expansion steps. The system can use Bayesian learning to chain the clusters at different expansion steps together. The system can expand the chain into a tree structure. The system can traverse the tree, for example, using beam search or tree search.

The system can generate an answer by consolidating over leaf nodes. For example, the system can use a language model to consolidate over the leaf nodes. As an example, the system can use the negative log-likelihoods for the intermediate answers to traverse the tree and consolidate over the leaf nodes. The answer thus includes multiple intermediate answers at different expansion steps, where each intermediate answer is generated conditioned on one or more previous intermediate answers.

In some examples, the system can use the language model to determine which leaves are most relevant to the prompt. The system can determine relevance by volume, length, emotional valence, or other text-based evaluations. In some examples, the system can generate the answer by providing the answers (e.g., the chain of intermediate answers leading to the leaf) generated for the most relevant leaves and a request to select the best answer to the one or more language models.

In some implementations, the system can use verifier models to filter out or reduce the weight assigned to intermediate answers and/or clusters of intermediate answers. For example, although a cluster may include a large number of intermediate answers relative to other clusters, the verifier model can determine that the intermediate answers of the cluster are logically inconsistent. In response, the system can filter out the intermediate answers of the cluster, or lower the probability that the cluster is selected to perform a further expansion step on.

In some implementations, the system can use validation nodes to improve the performance of the model. For example, if the validation nodes or verifier model conclude that an intermediate answer is not valid or does not fit certain criteria, the system can filter out those intermediate answers, and add them to an instruction fine-tuning training set for the model to train on. A training system of the system can further train the model on the fine-tuning training set.

In implementations where the system provides the input to different language models, the system can generate an answer by performing a probabilistic inference over each distribution. In these implementations, the system can determine an initial answer for each distribution, and then determine a final answer from the initial answers, for example, by repeating at least steps 430-450 for a new input. For example, the system can generate an input that includes the initial answers as multiple choice options for a multiple choice question derived from the prompt, and the set of documents for the prompt.

In some implementations, the system can generate a modified input that includes at least the answer and the set of documents. The system can provide the modified input to one or more language models. As an example, the modified input can include a request to generate a counterargument to the answer. Each language model can be configured to generate at least a secondary intermediate answer to the prompt from the modified input. The system can generate a second distribution from the secondary intermediate answers. The system can generate a response to the modified input by performing a probabilistic inference over the second distribution. The response can include natural language text.

In some implementations, the system can receive a request for an explanation for the answer. In these implementations, the system can generate an explanation made up of natural language text for the answer. For example, the system can use a language model to generate the explanation by providing the prompt, explanation, and answer as input to the one or more language models.

In some implementations, the system can obtain a second prompt. The second prompt can include, for example, a question and a deterministic answer, e.g., a yes or no, or a legal or not, answer. The system can generate a modified input that includes at least the deterministic answer and the set of documents. The modified input can also include the question of the second prompt. The system can perform the process 400 using the modified input as the obtained prompt. That is, each of the intermediate answers generated in step 440 supports or is indicative of the deterministic answer. In some implementations, the system can provide the modified input to one of multiple language models.

In some implementations, the system can generate a second prompt. The second prompt can include different text than the prompt, but with the same meaning. The system can generate the second prompt using a language model, for example. The system can provide an input that includes the prompt and an input that includes the second prompt to one or more machine learning models. The system can generate distributions for intermediate answers corresponding to the prompt and the second prompt. The system can generate the answer by performing a probabilistic inference over both distributions. In some implementations, the system can generate more prompts that include different text than the prompt but have the same meaning, and provide inputs that include the different prompts to the machine learning models.

FIG. 5 shows an example visualization 500 of a distribution of intermediate answers from a language model. The language model that generates the distribution in visualization 500 can be an auto-regressive neural network. For example, the language model can generate an output sequence of text tokens by generating each particular token in the output sequence conditioned on a current input sequence that includes any tokens that precede the particular text token in the output sequence, i.e., the tokens that have for already been generated for any previous positions in the output sequence that precede the particular position of the particular token. Each text token can be a string of text such as a character, a word, or a sentence, for example.

To generate a particular token at a particular position within a candidate output sequence, the language model can process the current input sequence to generate a score distribution, e.g., a probability distribution, that assigns a respective score, e.g., a respective probability, to each token in the vocabulary of tokens. The language model can then select, as the particular token, a token from the vocabulary using the score distribution. For example, the language model can greedily select the highest-scoring token or can sample, e.g., using nucleus sampling or another sampling technique, a token from the distribution.

Generally, a system such as system 100 can use the same language model to generate multiple different candidate output sequences in response to the same prompt, e.g., by using beam search decoding from score distributions generated by the language model, using a Sample-and-Rank decoding strategy, or using another decoding strategy that leverages the auto-regressive nature of the language model.

The example visualization 500 shows a distribution of different candidate output sequences in response to the same prompt, each candidate output sequence generated using a language model. The horizontal axis represents time or positions in an output sequence. The vertical axis is ordered by volume of text spans (reproduction of very similar ideas in an answer, or the relative proportion of intermediate answers that have the same meaning and are in the same cluster), or can be interpreted as the strength of a prediction of an answer. Each node 504 can represent a set of tokens, i.e., representing one or more words that the language model selects to be part of an output sequence. The set of tokens that the language model selects at each node 504 is described above, as generating a particular token at a particular position within a candidate output sequence. End nodes, such as end node 508, can represent the end or last set of tokens of an output sequence.

Each line, such as line 502, running horizontally between nodes, such as 504a and 504b (collectively, nodes 504), can represent a candidate output sequence of tokens, for example, that is an answer or makes up part of an answer. In some examples, each line can represent a sentence or an answer. Thus, the visualization 500 shows that the language model may select different sets of tokens at nodes at the same position, leading to different candidate output sequences. An answer generation system such as system 100 may thus select any of the candidate output sequences as the answer.

For example, the prompt may include a fact pattern and a question of whether the fact pattern constitutes hearsay. By providing an input that includes the prompt and a set of documents with relevant information to the language model multiple times, e.g., by sampling from the language model, the system can generate a distribution such as visualization 500. Each line such as line 502 can represent a different answer to the prompt. In some examples, each node 504 represents a word that is part of the answer that is selected by the language model. In other examples, each node 504 can represent multiple words at a particular expansion step, i.e., an intermediate answer, that are part of the answer.

Dotted lines such as line 502 can represent an affirmative answer to the question of hearsay. Solid lines such as line 506 can represent a negative answer to the question of hearsay. For example, line 506 can represent the answer “This is not hearsay because it was said in court,” where each word in the answer is a node. Line 502 can represent the answer: “This is hearsay because someone reported something they did not observe.” At each node, the system can select a different direction or argument to develop. Thus, each line represents a different answer to the prompt. The answer thus includes multiple intermediate answers at different expansion steps, where each intermediate answer is generated conditioned on one or more previous intermediate answers.

In general, language models or language model neural networks are machine learning models that can employ one or more layers of nonlinear units to predict an output for a received input. For example, each of the one or more language models can have any appropriate neural network architecture that allows the model to map an input sequence of text tokens from a vocabulary to an output sequence of text tokens from the vocabulary.

For example, the language model can have an encoder-decoder Transformer-based architecture.

As another example, the language model can have a decoder-only Transformer-based architecture, where the input sequence is provided as a “prompt” to the neural network.

In general a Transformer-based architecture can be one which is characterized by having a succession of self-attention neural network layers. A self-attention neural network layer has an attention layer input for each element of the input and is configured to apply an attention mechanism over the attention layer input to generate an attention layer output for each element of the input. There are many different attention mechanisms that may be used. For example, the neural network can use causal attention.

In particular, the language model can be an auto-regressive neural network that auto-regressively generates the output sequence of text tokens by generating each particular text token in the output sequence conditioned on a current input sequence that includes (i) the input sequence followed by (ii) any text tokens that precede the particular text token in the output sequence.

As a particular example, the language model can be an auto-regressive Transformer-based neural network that includes a plurality of layers that each apply a self-attention operation. The neural network can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv: 2203.15556, 2022; J. W. Rac, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d′Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CORR, abs/2112.11446, 2021; Colin Raffel, Noam Shazeer, Adam Roberts, Katherine Lec, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Lc. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neclakantan, Pranav Shyam, Girish Sastry, Amanda Askell, et al. Language models are few-shot learners. arXiv preprint arXiv: 2005.14165, 2020.

The tokens in the vocabulary can be any appropriate text tokens, e.g., words, word pieces, punctuation marks, characters, bytes, and so on that represent elements of text in one or more natural languages and, optionally, numbers and other text symbols that are found in a corpus of text. For example, the system can tokenize a given sequence of words by applying a tokenizer, e.g., the SentencePiece tokenizer (Kudo et al., arXiv: 1808.06226) or another tokenizer, to divide the sequence into tokens from the vocabulary.

Each of the one or more language models can have been pre-trained on a language modeling task, e.g., a task that requires predicting, given a current sequence of text tokens, the next token that follows the current sequence in the training data. Equivalently, the language modeling task can require, for each given unlabeled text sequence in a training data set, predicting a text sequence that followed the given unlabeled text sequence in a corresponding document. As a particular example, each of the language models can be pre-trained on a maximum-likelihood objective on a large dataset of text, e.g., text that is publicly available from the Internet or another text corpus.

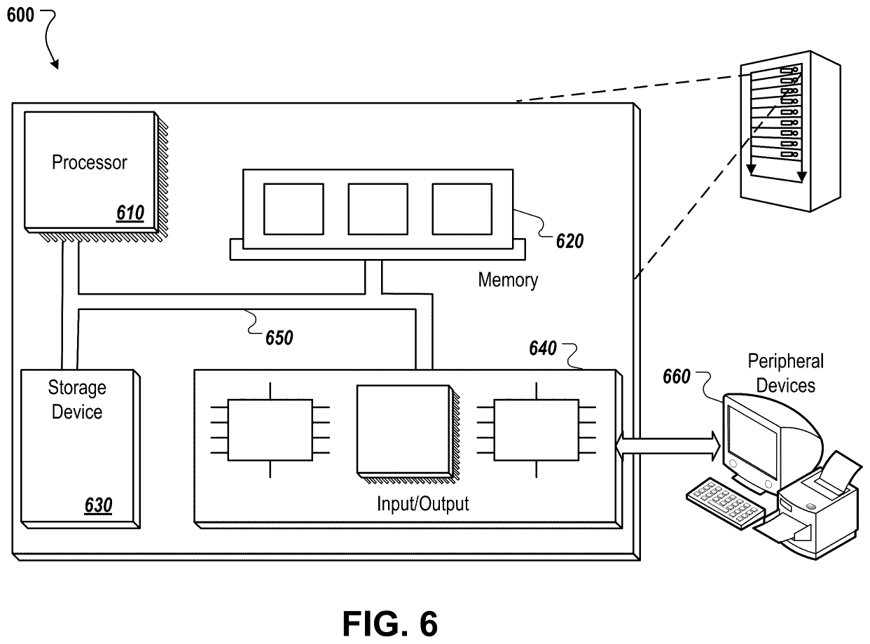

FIG. 6 depicts a schematic diagram of a computer system 600. The system 600 can be used to carry out the operations described in association with any of the computer-implemented methods described previously, according to some implementations. In some implementations, computing systems and devices and the functional operations described in this specification can be implemented in digital electronic circuitry, in tangibly-embodied computer software or firmware, in computer hardware, including the structures disclosed in this specification (e.g., system 600) and their structural equivalents, or in combinations of one or more of them. The system 600 is intended to include various forms of digital computers, such as laptops, desktops, workstations, personal digital assistants, servers, blade servers, mainframes, and other appropriate computers, including vehicles installed on base units or pod units of modular vehicles. The system 600 can also include mobile devices, such as personal digital assistants, cellular telephones, smartphones, and other similar computing devices. Additionally, the system can include portable storage media, such as, Universal Serial Bus (USB) flash drives. For example, the USB flash drives may store operating systems and other applications. The USB flash drives can include input/output components, such as a wireless transducer or USB connector that may be inserted into a USB port of another computing device.

The system 600 includes a processor 610, a memory 620, a storage device 630, and an input/output device 640. Each of the components 610, 620, 630, and 640 are interconnected using a system bus 650. The processor 610 is capable of processing instructions for execution within the system 600. The processor may be designed using any of a number of architectures. For example, the processor 610 may be a CISC (Complex Instruction Set Computers) processor, a RISC (Reduced Instruction Set Computer) processor, or a MISC (Minimal Instruction Set Computer) processor.

In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 may be a floppy disk device, a hard disk device, an optical disk device, or a tape device.

The input/output device 640 provides input/output operations for the system 600. In one implementation, the input/output device 640 includes a keyboard and/or pointing device. In another implementation, the input/output device 640 includes a display unit for displaying graphical user interfaces.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a key vectorboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment.

Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
obtaining a prompt comprising natural language text;
obtaining a set of documents comprising natural language text;
generating an input comprising at least the set of documents and the prompt;
providing the input to a plurality of language models, wherein each language model is configured to generate at least an intermediate answer to the prompt from the input;
generating a distribution from the intermediate answers; and
generating an answer to the prompt by performing a probabilistic inference over the distribution, the answer comprising natural language text.

2. The method of claim 1, wherein generating a distribution comprises clustering the intermediate answers based on similarity of each intermediate answer to each other intermediate answer.

3. The method of claim 1, wherein the plurality of language models comprise instances of a same language model.

4. The method of claim 1, wherein the plurality of language models comprise different language models.

5. The method of claim 1, wherein the method further comprises:
generating a modified input comprising at least the answer and the set of documents;
providing the modified input to a plurality of language models, wherein each language model is configured to generate at least a secondary intermediate answer to the prompt from the modified input;
generating a second distribution from the secondary intermediate answers; and
generating a response to the modified input by performing a probabilistic inference over the second distribution, the response comprising natural language text.

6. A method comprising:
obtaining a prompt comprising natural language text;
obtaining a set of documents comprising natural language text;
generating an input comprising at least the set of documents and the prompt;
providing the input to a plurality of language models, wherein each language model is configured to generate at least an intermediate answer to the prompt from the input;
for each language model:
generating a distribution of a plurality of intermediate answers by providing the input to the language model multiple times; and
generating an answer comprising natural language text to the prompt by performing a probabilistic inference over each distribution.

7. The method of claim 6, wherein generating a distribution comprises clustering the intermediate answers based on similarity of each intermediate answer to each other intermediate answer.

8. The method of claim 6, wherein the plurality of language models comprise multiple instances of a same language model.

9. The method of claim 6, wherein the input to each language model comprises a different prompt.

10. The method of claim 6, wherein obtaining a set of documents comprising natural language text further comprises obtaining a subset of the set of documents, wherein each document in the subset comprises text that is relevant to the prompt.

11. The method of claim 6, wherein the method further comprises:
receiving a request for an alternative to the answer; and
generating a second answer comprising natural language text to the prompt.

12. The method of claim 6, wherein the method further comprises:
receiving a request for an explanation for the answer; and
generating an explanation comprising natural language text for the answer.

13. The method of claim 6, wherein the method further comprises:
obtaining a second prompt comprising a deterministic answer comprising natural language text to the prompt;
generating a modified input comprising at least the second prompt and the set of documents;
providing the modified input to a plurality of language models, wherein each language model is configured to generate at least an intermediate answer to the prompt from the modified input;
for each language model:
generating a distribution of a plurality of intermediate answers by providing the modified input to the language model multiple times; and
generating an answer comprising natural language text to the prompt by performing a probabilistic inference over each distribution.

14. The method of claim 6, wherein the method further comprises:
generating a second prompt that comprises different text with a same meaning as the text of the prompt;
for each language model:
generating a first distribution of a plurality of first intermediate answers by providing the input to the language model multiple times;
generating a second distribution of a plurality of second intermediate answers by providing an input comprising at least the set of documents and the second prompt to the language model; and
generating the answer by performing a probabilistic inference over each distribution.

15. A system comprising:
one or more computers; and
one or more storage devices storing instructions that, when executed by the one or more computers, cause the one or more computers to perform respective operations comprising:
obtaining a prompt comprising natural language text;
obtaining a set of documents comprising natural language text;
generating an input comprising at least the set of documents and the prompt;
providing the input to a plurality of language models, wherein each language model is configured to generate at least an intermediate answer to the prompt from the input;
generating a distribution from the intermediate answers; and
generating an answer to the prompt by performing a probabilistic inference over the distribution, the answer comprising natural language text.

16. The system of claim 15, wherein generating a distribution comprises clustering the intermediate answers based on similarity of each intermediate answer to each other intermediate answer.

17. The system of claim 15, wherein the plurality of language models comprise instances of a same language model.

18. The system of claim 15, wherein the plurality of language models comprise different language models.

19. The system of claim 15, wherein the method further comprises:
generating a modified input comprising at least the answer and the set of documents;
providing the modified input to a plurality of language models, wherein each language model is configured to generate at least a secondary intermediate answer to the prompt from the modified input;
generating a second distribution from the secondary intermediate answers; and
generating a response to the modified input by performing a probabilistic inference over the second distribution, the response comprising natural language text.

20. One or more computer-readable storage media storing instructions that when executed by one or more computers cause the one or more computers to perform respective operations comprising:
obtaining a prompt comprising natural language text;
obtaining a set of documents comprising natural language text;
generating an input comprising at least the set of documents and the prompt;
providing the input to a plurality of language models, wherein each language model is configured to generate at least an intermediate answer to the prompt from the input;
generating a distribution from the intermediate answers; and
generating an answer to the prompt by performing a probabilistic inference over the distribution, the answer comprising natural language text.
